(19) United States
(12) Patent Application Publication
(10) Pub. No.: US 2010/0109859 A1
(43) Pub. Date: May 6, 2010

(54) Hazard Flasher System for Personal Motor Vehicles

(76) Inventor: Allen J. Lakosky, Virginia, MN (US)

Correspondence Address: MERCHANT & GOULD PC, P.O. BOX 2903, MINNEAPOLIS, MN, 55402-0903, US

(21) Appl. No.: 12/609,102

(22) Filed: Oct. 30, 2009

Related U.S. Application Data
(60) Provisional application No. 61/110,097, filed on Oct. 31, 2008.

(51) Int. Cl. B60Q 1/52; H01R 43/00

(52) U.S. Cl. 340/471; 29/825

(57) ABSTRACT

A hazard flasher system for a personal motor vehicle is disclosed. The hazard flasher system comprises at least a first light-emitting diode (LED), a second LED, and a circuit board. The first LED is mounted on the personal motor vehicle such that light from the first LED is projected generally forward from the personal motor vehicle. The second LED is mounted on the personal motor vehicle such that light from the second LED is projected generally rearward from the personal motor vehicle. The circuit board uses electrical energy from the personal motor vehicle's primary battery to output periodic pulses of electric energy that cause the first and second LEDs to flash.

This application claims the benefit of U.S. Provisional Application No. 61/110,097, filed Oct. 31, 2008, the entirety of which is hereby incorporated by reference.

### BACKGROUND

Disabled motor vehicles are a major danger on roadways and trails. Hundreds of people die or are seriously wounded by collisions with disabled motor vehicles. Drivers of other vehicles typically do not expect to encounter disabled motor vehicles and may collide with the disabled vehicles with catastrophic consequences. Collisions with disabled motor vehicles are especially prevalent at night because disabled motor vehicles are difficult for other drivers to see.

To reduce the chances of collisions with disabled vehicles, many types of motor vehicles have hazard flasher features. For example, the hazard flasher systems of most automobiles and motorcycles cause the vehicle's left and right turn signals to blink simultaneously. The simultaneous blinking on the motor vehicle's turn signals is generally sufficient to attract the notice of other drivers, enabling the other drivers to avoid the motor vehicle. In another example, the hazard flasher systems of other types of motor vehicles cause the headlights and taillights of the motor vehicle to blink

In a typical motor vehicle, a starter motor uses electrical energy from a primary battery to start the motor vehicle's internal combustion engine. In addition, the hazard flasher system of the motor vehicle uses electrical energy from the primary battery to make the headlights, taillights, and/or turn signals flash. The headlights, taillights, and turn signals of the motor vehicle use significant amounts of electricity. For this reason, extended use of the motor vehicle's emergency flasher system depletes the primary battery to the point where there is not enough energy remaining in the primary battery for the starter motor to start the motor vehicle's internal combustion engine. This is especially problematic for smaller, personal motor vehicles such as motorcycles, snowmobiles, and personal watercraft because of their smaller primary batteries.

Furthermore, incandescent light bulbs conventionally used in headlights, taillights, and turn signals are vulnerable to breakage due to vibration. Vibration is especially problematic for smaller, personal motor vehicles such as motorcycles, snowmobiles, lawn mowers, and personal watercraft because of their use on rougher surfaces and their smaller engines.

### SUMMARY

This disclosure describes a hazard flasher system for a personal motor vehicle. As described herein, the hazard flasher system comprises at least a first light-emitting diode (LED), a second LED, and a circuit board. The first LED is mounted on the personal motor vehicle such that light from the first LED is projected generally forward from the personal motor vehicle. The second LED is mounted on the personal motor vehicle such that light from the second LED is projected generally rearward from the personal motor vehicle. The circuit board uses electrical energy from the personal motor vehicle's primary battery to output periodic pulses of electric energy that cause the first and second LEDs to flash.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example block diagram of a hazard flasher system for a personal motor vehicle.

FIG. 2 illustrates an example diagram of an LED assembly of the hazard flasher system.

FIG. 3 is a schematic diagram that illustrates a first example implementation of a circuit board of the hazard flasher system.

FIG. 4 is a schematic diagram that illustrates a second example implementation of the circuit board of the hazard flasher system.

FIG. 5 is a flowchart that illustrates an example operation to install the hazard flasher system.

FIG. 6 is an example personal motor vehicle that includes the hazard flasher system.

### DETAILED DESCRIPTION

As briefly described above, this disclosure is directed to a hazard flasher system for a personal motor vehicle. As described herein, the hazard flasher system includes front-facing and rear-facing light-emitting diodes (LEDs). One or more electrical leads connect these LEDs to a circuit board. The circuit board conditions electrical energy from a primary battery of the personal motor vehicle and outputs periodic pulses of electrical energy to the electrical lead or leads that connect the LEDs to the circuit board. Each of the periodic pulses of electrical energy causes the LEDs to flash.

In some embodiments, the LEDs use far less energy than light bulbs used in conventional hazard flasher systems. In such embodiments, because the LEDs require less energy than conventional automotive headlights, taillights, or turn signals, it may take significantly more time for the hazard flasher system described herein to deplete the primary battery of the personal motor vehicle than a conventional hazard flasher system. Allowing the hazard flasher system to operate for lengthy periods of time may be important in situations where the operator of the personal motor vehicle is forced to leave the personal motor vehicle at a road or trail side when personal motor vehicle runs out of fuel.

In some embodiments, an alternator in the personal motor vehicle recharges the primary battery of the personal motor vehicle when the internal combustion engine of the personal motor vehicle is operating. In such embodiments, the operator of the personal motor vehicle may not need to be concerned about changing batteries for the hazard flasher system because the hazard flasher system draws electrical energy from the primary battery of the personal motor vehicle, which is recharged by the alternator.

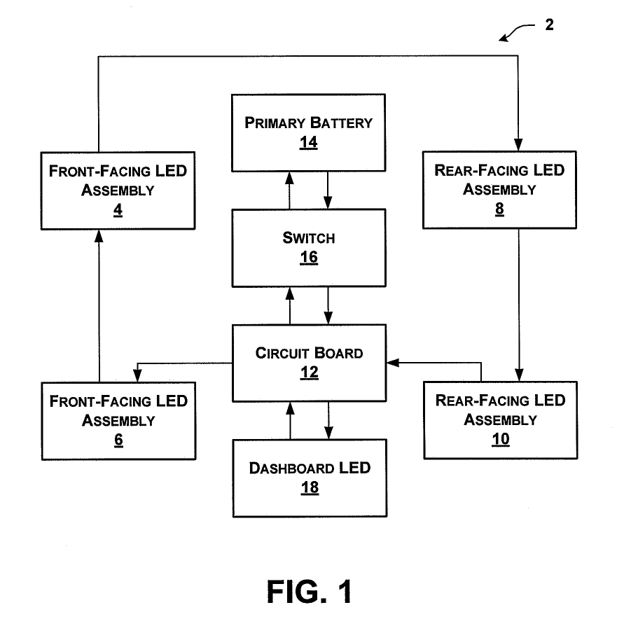

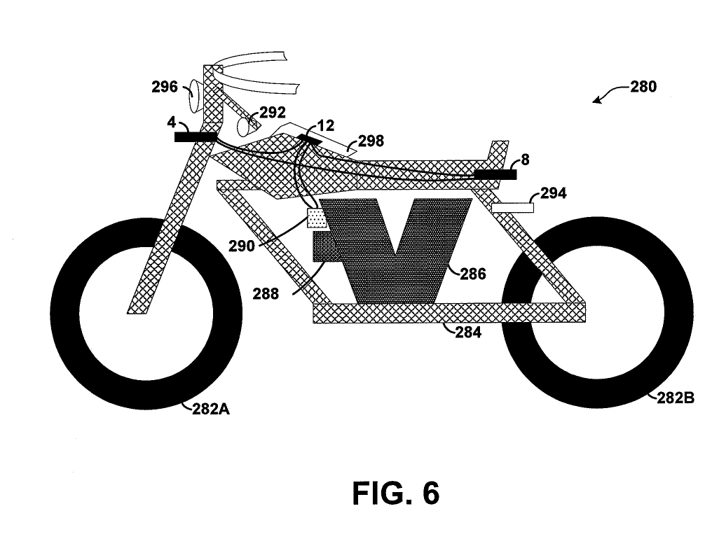

FIG. 1 illustrates an example block diagram of a hazard flasher system 2 for a personal motor vehicle (see e.g., personal motor vehicle 280 in FIG. 6). Hazard flasher system 2 may be installed on a wide variety of personal motor vehicles. For example, hazard flasher system 2 may be installed on motorcycles, scooters, mopeds, dirt bikes, three and four wheeled all-terrain vehicles, motorized tricycles, personal watercraft, golf carts, tomcars, tractors, riding lawnmowers, snowmobiles, go-karts, motorized wheelchairs, Segway personal transporters, motorized rickshaws, and other types of small motorized vehicles. Examples of vehicles that are not personal motor vehicles are cars, trucks, vans, buses, ships, yachts, motor homes, trailers, airplanes, helicopters, spacecraft, or other large vehicles.

As illustrated in the example of FIG. 1, hazard flasher system 2 comprises a first forward-facing LED assembly 4, a second forward-facing LED assembly 6, a first rear-facing LED assembly 8, and a second rear-facing LED assembly 10. It should be appreciated that some versions of hazard flasher system 2 may comprise more or fewer LED assemblies. For example, one version of hazard flasher system 2 may only include a single forward-facing LED assembly and a single rear-facing LED assembly. In another example, another version of hazard flasher system 2 may comprise two forward-facing LED assemblies, two rear-facing LED assemblies, and two side-facing LED assemblies.

Each of LED assemblies 4-10 includes a high-brightness LED. In some embodiments, the LEDs in front-facing LED assemblies 4 and 6 emit yellow light and the LEDs in rear-facing LED assemblies 8 and 10 emit red light. The color of the light emitted by the LEDs in the LED assemblies thus serves to alert the drivers of other vehicles about the orientation of the personal motor vehicle in which hazard flasher system 2 is installed.

Front-facing LED assemblies 4 and 6 are suitable for mounting to a front end of the personal motor vehicle. In various embodiments, front-facing LED assemblies 4 and 6 are attached to the personal motor vehicle in various ways. For example, front-facing LED assemblies 4 and 6 may include adhesive pads that stick to the personal motor vehicle, clamps that attach to the personal motor, a fastening assembly (e.g., nuts and bolts), or other elements that render the front-facing LED assemblies suitable for mounting to the personal motor vehicle. Furthermore, in various embodiments, front-facing LED assemblies 4 and 6 are mounted at a variety of places on the front side of the personal motor vehicle. For example, front-facing LED assemblies 4 and 6 may be mounted adjacent to the front headlight or headlights of the personal motor vehicle. In another example, front-facing LED assemblies 4 and 6 may be mounted on a handlebar of the personal motor vehicle. In yet another example, front-facing LED assemblies 4 and 6 may be mounted inside or outside housings that enclose the front headlights or front turn signals of the personal motor vehicle. In addition to these examples, front-facing LED assemblies 4 and 6 may be mounted in many other locations.

Rear-facing LED assemblies 8 and 10 are suitable for mounting to a rear end of the personal motor vehicle. In various embodiments, rear-facing LED assemblies 8 and 10 are mounted at a variety of places on the rear side of the personal motor vehicle. For example, rear-facing LED assemblies 8 and 10 may be mounted adjacent to the personal motor vehicle's taillight or taillights. In another example, rear-facing LED assemblies 8 and 10 may be mounted at the outer rear corners of the personal motor vehicle. In yet another example, the rear-facing LED assemblies 8 and 10 may be mounted inside or outside housings that enclose the taillights or rear turn signals.

An electrical lead connects LED assemblies 4-10. In various embodiments, LED assemblies 4-10 are connected to the electrical lead in series or in parallel. In the example of FIG. 1, the lead is illustrated as a set of arrows connecting LED assemblies 4-10.

Hazard flasher system 2 includes a primary battery 14. A starter motor of the personal motor vehicle uses electrical current from primary battery 14 to start the internal combustion engine of the personal motor vehicle. In some embodiments, an alternator of the personal motor vehicle uses energy from the internal combustion engine of the personal motor vehicle to recharge primary battery 14. In various embodiments, primary battery 14 is mounted at various locations within the personal motor vehicle. For instance, primary battery 14 may be mounted at a location within the personal motor vehicle such that primary battery 14 receives some thermal energy from the internal combustion engine. The thermal energy from the internal combustion engine may have an effect of increasing the electrical energy output of primary battery 14. This effect may be valuable in cold weather conditions when batteries that do not receive thermal energy from the internal combustion engine produce insufficient electrical energy output to power a hazard flasher system.

Hazard flasher system 2 also comprises a circuit board 12. When hazard flasher system 2 is activated, direct current (DC) electrical energy flows from primary battery 14 of the personal motor vehicle to circuit board 12. Circuit board 12 transforms the electrical energy from primary battery 14 and outputs periodic pulses of electrical energy to LED assemblies 4-10. Each of these pulses of electrical energy cause the LEDs in LED assemblies 4-10 to emit light. When circuit board 12 is not outputting a pulse of electrical energy, the LEDs in LED assemblies 4-10 do not emit light. Hence, because circuit board 12 outputs pulses of electrical energy on a periodic basis, the LEDs flash on and off.

In various embodiments, the circuit board 12 outputs the pulses of electrical energy at various frequencies. In one example, circuit board 12 includes a 555 timer integrated circuit that receives the DC electrical energy from primary battery 14 and produces a 0.67 hertz pulse with a 10% duty cycle (i.e., circuit board 12 outputs one pulse every 1.5 seconds). This pulse drives an NPN transistor that enables and disables an LED driver integrated circuit. The LED driver integrated circuit is a continuous mode, step-down converter that utilizes a current sense resistor to set a nominal average output current (450 mA) to drive the LEDs in LED assemblies 4-10.

In various embodiments, circuit board 12 is mounted within the personal motor vehicle in various places. For example, circuit board 12 may be mounted beneath or within the dashboard of the personal motor vehicle. In another example, circuit board 12 may be mounted in an electrical subsystem that controls other lights of the personal motor vehicle.

In some embodiments, circuit board 12 is wired to primary battery 14 such that circuit board 12 is able to receive electrical energy from primary battery 14 even when the personal motor vehicle is not in an “on” state. For example, circuit board 12 may receive electrical energy from primary battery 14 when a driver has turned off the personal motor vehicle. Because circuit board 12 is able to receive electrical energy from primary battery 14 even when the personal motor vehicle is not in the “on” state, the driver of the personal motor vehicle can leave the personal motor vehicle to seek assistance while hazard flasher system 2 is operational. Furthermore, in some embodiments, circuit board 12 is wired to primary battery 14 such that circuit board 12 is able to receive electrical energy from primary battery 14 when the driver has removed the personal motor vehicle's ignition key from the ignition switch. Thus, hazard flasher system 2 can remain operational when the ignition key is not in the ignition switch. Because the driver can maintain possession of the ignition key while away from the personal motor vehicle while hazard flasher system 2 is operational, the personal motor vehicle may be at a decreased risk of theft during the driver's absence.

In some embodiments, circuit board 12 is designed to utilize DC electrical energy having a voltage that ranges from 6.25 volts to 15 volts. The ability to utilize DC electrical energy having this voltage range allows hazard flasher system 2 to be utilized in a variety of different types of personal motor vehicles having different types of primary batteries.

Hazard flasher system 2 comprises a switch 16. When switch 16 is in a closed position, electrical energy can flow from primary battery 14 to circuit board 12 and onward, thereby activating hazard flasher system 2. When switch 16 is in an open position, electrical energy cannot flow from primary battery 14 to circuit board 12, thereby deactivating hazard flasher system 2. Switch 16 may be mounted at a variety of places on the personal motor vehicle. For example, switch 16 may be mounted within the dashboard of the personal motor vehicle.

In addition, hazard flasher system 2 includes a dashboard LED 18 that is designed to be included in the dashboard of the personal motor vehicle. The purpose of dashboard LED 18 is to inform a driver of the personal motor vehicle whether hazard flasher system 2 is activated or deactivated. In other words, the role of dashboard LED 18 is similar to the role of the in-dash turn signal lamps that inform a driver of a car whether the car's turn signals have been activated. Dashboard LED 18 receives the pulses of electrical energy outputted by the circuit board 12. Consequently, dashboard LED 18 flashes on and off at the same rate as the LEDs in LED assemblies 4-10. Because dashboard LED 18 should not blind or distract the driver of the personal motor vehicle, dashboard LED 18 does not emit as much light at the LEDs in LED assemblies 4-10.

Hazard flasher system 2 may be installed on the personal motor vehicle during or after production of the personal motor vehicle. For instance, hazard flasher system 2 may be installed on the personal motor vehicle at the factory that assembles the personal motor vehicle. In another example, hazard flasher system 2 may be implemented as an after-market kit that can be installed on the personal motor vehicle at home or at a mechanic's shop.

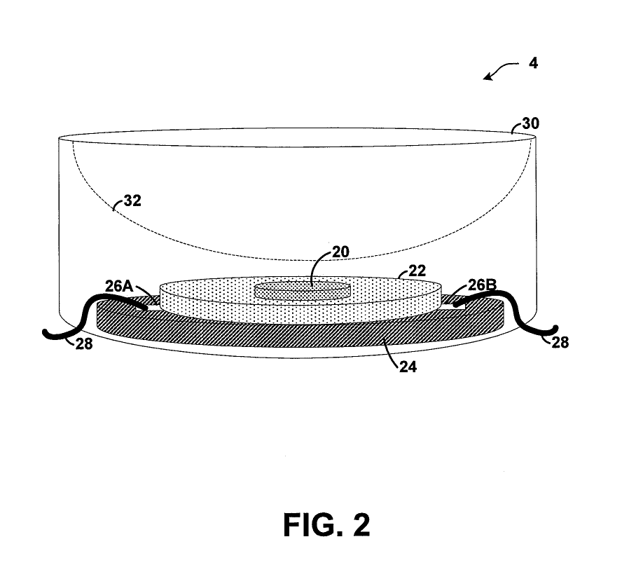

FIG. 2 illustrates an example diagram of front-facing LED assembly 4. Although FIG. 2 illustrates an example diagram of front-facing LED assembly 4, it should be appreciated that any of LED assemblies 6, 8, or 10 may include all of the details illustrated in the example of FIG. 2.

As illustrated in the example of FIG. 2, front-facing LED assembly 4 may comprise a LED 20. LED 20 may be a variety of different types of LEDs. For example, LED 20 may be any type of LED that is capable of handling at least a 350-400 milliampere pulse. In this example, LED 20 may be a red, 625 nm SMD PLATINUM DRAGON or a yellow 590 nm SMD PLATINUM DRAGON manufactured by Osram Opto Semiconductors, Inc. of Regensburg, Germany.

In addition, front-facing LED assembly 4 comprises a thermal substrate 22 attached to a base 24. Thermal substrate 22 includes a first connection point 26A and a second connection point 26B. An incoming segment of lead 28 is soldered to connection point 26A and an outgoing segment of lead 28 is soldered to connection point 26B. In this way, connection points 26A and 26B receive electrical energy from lead 28, provide the electrical energy to LED 20, and transmit electrical energy back to lead 28.

Thermal substrate 22 effectively conducts heat away from LED 20 and onto base 24, thereby keeping LED 20 cool. Thermal substrate 22 may be a variety of different types of thermal substrate. For example, thermal substrate 22 may be a T-Clad metal core printed circuit board for Dragon series LEDs manufactured by the Bergquist Company of Chanhassen, Minn. Base 24 may be made of aluminum or another material that readily conducts heat.

Each of front-facing LED assembly 4 also comprises a lens 30. Lens 30 physically protects LED 20 and disperses light emitted by LED 20. Lens 30 may be a Golden Dragon Clear Lens Holder sold by Dialight Corporation of Farmingdale, N.J. In some instances, lens 30 may have an inner surface 32 that, in profile, is parabola-shaped. In these instances, LED 20 may be positioned within lens 30 such that LED 20 is at the focus of the parabola-shaped inner surface 32. As a result, lens 30 may generally project much of the light emitted by LED 20 in a single outward direction. However, light emitted by LED 20 may, in some implementations, escape from the sides of lens 30. In such implementations, the light may serve to alert drivers to the presence of the personal motor vehicle when the drivers are approaching the personal motor vehicle from the side of the personal motor vehicle.

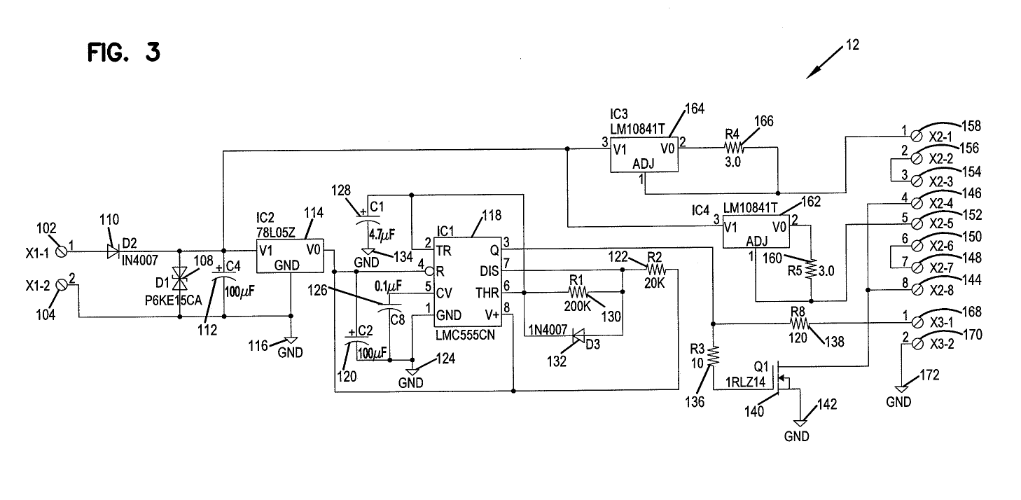

FIG. 3 is a schematic diagram that illustrates a first example implementation of circuit board 12 of hazard flasher system 2. As illustrated in the example of FIG. 3, a first wire is connected to a first connector 102 and a second connector 104 is connected to a second wire. First connector 102 is the positive side of the applied DC voltage and second connector 104 is the negative side of the applied DC voltage.

Second connector 104 is connected to a first diode 108. First diode 108 is connected to a second diode 110 that is connected to first connector 102. Second diode 110 provides reverse polarity protection against incorrectly applied voltage. First diode 108 provides transient voltage suppression. First diode 108 may, in some example implementations, provide transient voltage suppression at a 15 volt threshold. In the example of FIG. 3, first diode 108 may be a P6KE15CA-T diode manufactured by Diodes, Inc. of Dallas, Tex. Furthermore, in the example of FIG. 3, second diode 110 may be a 1N4007-T rectifier diode manufactured by Diodes, Inc.

Second connector 104, first diode 108, and second diode 110 are connected to a fourth capacitor 112. Fourth capacitor 112 provides filtering for the applied DC voltage. In one example implementation, fourth capacitor 112 has a capacitance of 100 microfarads.

Second connector 104, first diode 108, second diode 110, and fourth capacitor 112 are connected to a voltage input pin of a voltage regulator 114. Voltage regulator 114 may reduce the applied DC voltage to five volts. In one example implementation, voltage regulator 114 is a LM78L05ACZ/NOPB integrated circuit voltage regulator manufactured by National Semiconductor, Inc. of Santa Clara, Calif. A ground pin of voltage regulator 114 is connected to a ground 116.

A voltage output pin of voltage regulator 114 is connected to a reset pin of a timer 118, a positive voltage supply pin of timer 118, a second capacitor 120, and a second resistor 122. Timer 118 may be a 555 timer configured for astable operation. In one example implementation, timer 118 is a LMC555CN integrated circuit timer manufactured by National Semiconductor, Inc.

Second capacitor 120 provides filtering for the five volt supply provided by voltage regulator 114. In one example implementation, second capacitor 120 has a capacitance of 100 microfarads. Second capacitor 120 is connected to a ground 124, a ground pin of timer 118, and a third capacitor 126. Third capacitor 126 provides a bypass for noise for timer 118. Third capacitor 126 is also connected to a control voltage pin of timer 118. In one example implementation, third capacitor 126 has a capacitance of 0.1 microfarads.

Second resistor 122 has a resistance value that, in conjunction with a first capacitor 128, dictates the timer charge time of timer 118. Second resistor 122 is connected to a discharge pin of timer 118, a first resistor 130, and an anode end of a third diode 132. First resistor 130 is connected to a threshold pin, a trigger pin of timer 118, and a cathode end of third diode 132. First resistor 130 has a resistance value that, in conjunction with first capacitor 128, dictates the discharge time of timer 118. In one example implementation, first resistor 130 has a resistance of 200 kilo-ohms.

Third diode 132 acts as a bypass for first resistor 130 during the charge cycle of timer 118 in order to obtain a 10% duty cycle. As illustrated in the example of FIG. 3, the cathode end of third diode 132 is connected to the threshold pin of timer 118, first resistor 130, the trigger pin of timer 118, and first capacitor 128. The anode end of third diode 132 is connected to first resistor 130, second resistor 122, and the discharge pin of timer 118. In one example implementation, third diode 132 is a 1N4007-T rectifier diode manufactured by Diodes, Inc.

A first electrode of first capacitor 128 is connected the trigger pin of timer 118, first resistor 130, and third diode 132. A second electrode of first capacitor 128 is connected to a ground 134. First capacitor 128 provides timing for the charge and discharge cycles of timer 118. In one example implementation, first capacitor 128 has a capacitance of 4.7 microfarads.

A first end of a third resistor 136 and a first end of a sixth resistor 138 are connected to an output pin of timer 118. A second end of third resistor 136 is connected to a metal-oxide-semiconductor field-effect transistor (MOSFET) 140. Third resistor 136 serves as a bias resistor for MOSFET 140. In one example implementation, third resistor 136 has a resistance of 10 ohms.

MOSFET 140 is an N-channel logic level MOSFET that supplies ground pulses to the high-brightness LEDs. MOSFET 140 is connected to a ground 142, a connector 144, and a connector 146. Connector 144 is a negative (cathode) connection to a first high-brightness LED that is connected to a connector 148 that is a positive (anode) connection to the first high-brightness LED. Connector 148 is connected to a connector 150 that is a negative connection to a second high-brightness LED that is connected to a connector 152 that is a positive connection to the second high-brightness LED.

Connector 146 is a negative connection to a third high-brightness LED that is connected to a connector 154 that is a positive connection to the third high-brightness LED. Connector 154 is connected to a connector 156 that is a negative connection to a fourth high-brightness LED that is connected to a connector 158 that is a positive connection to the fourth high-brightness LED.

Connector 152 is connected to a first end of a fifth resistor 160 and an adjustment pin of an adjustable voltage regulator 162. A second end of fifth resistor 160 is connected to a voltage output pin of adjustable voltage regulator 162. Adjustable voltage regulator 162 is configured as a constant current source to provide positive voltage to the first high-brightness LED and the second high-brightness LED. Fifth resistor 160 acts in conjunction with adjustable voltage regulator 162 to set the constant current source. In one example implementation, fifth resistor 160 has a resistance of 3.0 ohms. A voltage input pin of adjustable voltage regulator 162 is connected to first diode 108, second diode 110, fourth capacitor 112, voltage regulator 114, and a voltage input pin of an adjustable voltage regulator 164.

Connector 158 is connected to a first end of a fourth resistor 166 and an adjustment pin of adjustable voltage regulator 164. A second end of fourth resistor 166 is connected to a voltage output pin of adjustable voltage regulator 164. Adjustable voltage regulator 164 is configured as a constant current source to provide positive voltage to the third high-brightness LED and the fourth high-brightness LED. Fourth resistor 166 acts in conjunction with adjustable voltage regulator 164 to set the constant current source. In one example implementation, fourth resistor 166 has a resistance of 3.0 ohms. A voltage input pin of adjustable voltage regulator 164 is connected to first diode 108, second diode 110, fourth capacitor 112, voltage regulator 114, and the voltage input pin of adjustable voltage regulator 162.

A second end of sixth resistor 138 is connected to a connector 168. Connector 168 is a positive connection to a dashboard LED. A connector 170 is a negative connection to the dashboard LED. Connection 170 is connected to a ground 172.

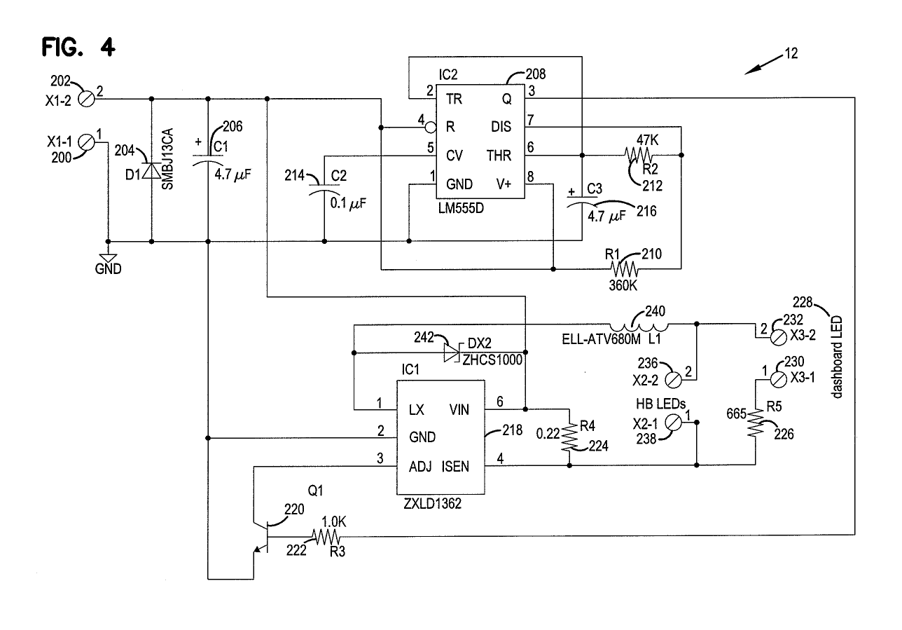

FIG. 4 is a schematic diagram that illustrates a second example implementation of circuit board 12 of hazard flasher system 2. As illustrated in the example of FIG. 4, circuit board 12 includes a first connector 200, a second connector 202, a first diode 204, a first capacitor 206, a timer 208, a first resistor 210, a second resistor 212, a second capacitor 214, a third capacitor 216, an LED driver 218, a switching transistor 220, a third resistor 222, a fourth resistor 224, a fifth resistor 226, a dashboard LED 228, a positive connector 230, a negative connector 232, a negative connector 236, a positive connector 238, an inductor 240, and a second diode 242.

First connector 200 provides a negative side of the applied DC voltage. Second connector 202 provides a positive side of the applied DC voltage. First connector 200 is connected to an anode end of first diode 204 and second connector 202 is connected to a cathode end of first diode 204. First diode 204 provides transient voltage suppression at a 15 volt threshold. The cathode end of first diode 204 is connected to first capacitor 206. First capacitor 206 provides filtering for the applied DC voltage. First capacitor 206 is connected to first connector 200 and second connector 202. In one example implementation, first capacitor 206 has a capacitance of 4.7 microfarads.

First capacitor 206 is interconnected with a reset pin of timer 208. Timer 208 is configured for astable operation. In one example implementation, timer 208 is a 555 timer. In one particular instance, timer 208 is a LMC555CM/NOPB integrated circuit timer manufactured by National Semiconductor, Inc. of Santa Clara, Calif. First resistor 210 is connected to second resistor 212, a discharge pin of timer 208, and a positive voltage supply pin of timer 208. Second resistor 212 is connected to a discharge pin, a threshold pin of timer 208, and a trigger pin of timer 208. The resistance of first resistor 210, in conjunction with first capacitor 206 and second resistor 212, dictates the charge time of timer 208. The resistance of second resistor 212, in conjunction with first capacitor 206, dictates the discharge time of timer 208. In one example implementation, first resistor 210 has a resistance of 360 kilo-ohms and second resistor 212 has a resistance of 47 kilo-ohms.

In the example of FIG. 4, a control voltage pin of timer 208 is connected to a first end of second capacitor 214. A second end of second capacitor 214 is connected to a ground pin of timer 208, first capacitor 206, first diode 204, first connector 200, third capacitor 216, a ground pin of LED driver 218, and NPN switching transistor 220. In one example implementation, second capacitor 214 has a capacitance of 0.1 microfarads. Second capacitor 214 provides a bypass for noise for timer 208.

A threshold pin of timer 208 is connected to third capacitor 216, second resistor 212, and a trigger pin of timer 208. Third capacitor 216 provides timing for the charge and discharge cycles of timer 208. In one example implementation, third capacitor 216 has a capacitance of 4.7 microfarads.

Second capacitor 214 and third capacitor 216 are connected to LED driver 218 and NPN switching transistor 220. LED driver 218 is a continuous mode step-down converter LED driver. In one example implementation, LED driver 218 is a ZXLD1362ET5CT-ND integrated circuit LED driver manufactured by Zetex, Inc. of Oldham, UK. NPN switching transistor 220 enables and disables LED driver 218. NPN switching transistor 220 is also connected to third resistor 222 that is also connected to an output pin of timer 208. In one example implementation, third resistor 222 has a resistance of 1.0 kilo-ohms. Third resistor 222 is a base current limiting resistor for NPN switching transistor 220.

LED driver 218 is connected to fourth resistor 224. Fourth resistor 224 is a current sense resistor that sets the nominal output current. For example, fourth resistor 224 may set the nominal output current at 450 mA. In one example implementation, fourth resistor 224 has a resistance of 0.22 ohms. Fourth resistor 224 is also connected to fifth resistor 226. Fifth resistor 226 is a current limiting resistor for dashboard LED 228. In one example implementation, fifth resistor 226 has a resistance of 665 ohms. Fifth resistor 226 is connected to a positive (anode) connector 230 to dashboard LED 228. Negative connector 232 is also connected to negative connector 236 that is connected to dashboard LED 228.

A positive connector 238 is connected to LED driver 218 and the high-brightness LEDs. Negative connector 236 is also connected to the high-brightness LEDs.

Negative connector 236 and negative connector 232 are connected to inductor 240. Inductor 240 is also connected to LED driver 218 and second diode 242. Second diode 242 provides for switching and blocking inductive kickback. Second diode 242 is connected to LED driver 218. Second diode 242 may be a Schottky diode. Inductor 240 may have an inductance of a 68 micro-Henrys (μH). In one example implementation, inductor 240 may be an ELL-ATV680M inductor manufactured by Panasonic Industrial Company of Osaka, Japan.

LED driver 218 is also connected to first capacitor 206 and to the anode end of first diode 204.

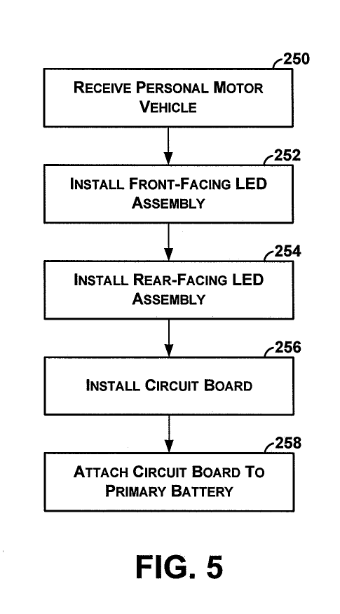

FIG. 5 illustrates an example operation to install hazard flasher system 2. As illustrated in the example of FIG. 5, the operation may begin with receiving a personal motor vehicle (250). Next, a technician installs a front-facing LED assembly (e.g., front-facing LED assembly 4) in the personal motor vehicle (252). The technician may then install a rear-facing LED assembly (e.g., rear-facing LED assembly 8) in the personal motor vehicle (254).

After the technician installs the front-facing LED assembly and the rear-facing LED assembly, the technician may install a circuit board (e.g., circuit board 12) in the personal motor vehicle (256). For instance, the technician may install the circuit board beneath a dashboard of the personal motor vehicle. After the technician installs the circuit board in the personal motor vehicle, the technician may attach the circuit board to an electrical system that derives electrical energy from a primary battery (e.g., primary battery 14) of the personal motor vehicle (258). The technician may attach the circuit board to the primary battery by connecting the circuit board to the electrical system of the personal motor vehicle.

It should be appreciated that the operation illustrated in the example of FIG. 5 is merely one example. In other example operations, there may be more or fewer steps and/or the steps may be performed in a different order.

FIG. 6 is an example personal motor vehicle 280 that includes hazard flasher system 2. In the example of FIG. 6, personal motor vehicle 280 is a motorcycle. However, it should be appreciated that hazard flasher system 2 may be installed on a wide variety of personal motor vehicles.

In the example of FIG. 6, personal motor vehicle 280 comprises a first wheel 282A and a second wheel 282B. Personal motor vehicle 280 also comprises a frame 284. An internal combustion engine 286 is mounted to frame 284. Internal combustion engine 286 drives personal motor vehicle 280.

Personal motor vehicle 280 is also equipped with a starter motor 288 and a primary battery 290. Primary battery 290 stores electrical energy. Starter motor 288 uses electrical energy from primary battery 290 to start internal combustion engine 286.

Furthermore, in the example of FIG. 6, personal motor vehicle 280 includes a set of front turn signals 292 and a set of rear turn signals 294. Front turn signals 292 and rear turn signals 294 may include incandescent light bulbs. In addition, personal motor vehicle 280 includes a headlight 296. In some embodiments, headlight 296 includes an incandescent or halogen light bulb.

Personal motor vehicle 280 includes a dashboard 298. Dashboard 298 may include instruments that convey information about personal motor vehicle 280. For instance, dashboard 298 may include a speedometer, a tachometer, a gas gauge, and other instruments. Circuit board 12 (FIG. 1) is installed in dashboard 298. Circuit board 12 is connected to front-facing LED assembly 4 (FIG. 1) and rear-facing LED assembly 8 (FIG. 1). As is apparent from the example of FIG. 6, front-facing LED assembly 4 is installed at the front of personal motor vehicle 280 and rear-facing LED assembly 8 is installed at the rear of personal motor vehicle 280. In this way, light emitted from front-facing LED assembly 4 is projected generally forward and light emitted from rear-facing LED assembly 8 is projected generally rearward.

The techniques of this disclosure may be realized in many ways. For example, the techniques of this disclosure may be realized as a hazard flasher system for a personal motor vehicle, the hazard flasher system comprising a first light-emitting diode (LED) suitable for mounting to a front end of the personal motor vehicle. The hazard flasher system also comprises a second LED suitable for mounting to a rear end of the personal motor vehicle. In addition, the hazard flasher system comprises a circuit board that, when the hazard flasher system has been activated, utilizes direct current electrical energy from a primary battery of the personal motor vehicle to output periodic pulses of electrical energy to the first LED and the second LED, the pulses of electrical energy causing the first LED and the second LED to flash.

In another example, the techniques of this disclosure may be realized as a personal motor vehicle comprising an internal combustion engine that drives the personal motor vehicle. The personal motor vehicle also comprises a primary battery that stores electrical energy. In addition, the personal motor vehicle comprises a starter motor that uses electrical energy from the primary battery to start the internal combustion engine. The personal motor vehicle also comprises a hazard flasher system that comprises a first light-emitting diode (LED) suitable for mounting to a front end of the personal motor vehicle. The hazard flasher system comprises a second LED suitable for mounting to a rear end of the personal motor vehicle. In addition, the hazard flasher system comprises a circuit board that, when the hazard flasher system has been activated, utilizes direct current electrical energy from the primary battery of the personal motor vehicle to output periodic pulses of electrical energy to the first LED and the second LED, the pulses of electrical energy causing the first LED and the second LED to flash.

In another example, the techniques of this disclosure may be realized as a method of installing a hazard flasher system on a personal motor vehicle. In this example, the method comprises installing a forward-facing light-emitting diode (LED) assembly on the personal motor vehicle such that light emitted by an LED in the forward-facing LED assembly is projected generally forward from the personal motor vehicle. The method also comprises installing a rear-facing LED assembly on the personal motor vehicle such that light emitted by an LED in the rear-facing LED assembly is projected generally rearward from the personal motor vehicle. Furthermore, the method comprises attaching a lead wire to an electrical system of the personal motor vehicle, the electrical system of the personal motor vehicle deriving electrical energy from a primary battery of the personal motor vehicle. In addition, the method comprises attaching a return wire to the electrical system of the personal motor vehicle. The method also comprises installing a circuit board attached to the lead wire and the return wire, the circuit board utilizing direct current (DC) electrical energy provided by the electrical system to output periodic pulses of electrical energy to the forward-facing LED assembly and the rear-facing LED assembly, the pulses of electrical energy causing the LED in the forward-facing LED assembly and the LED in the rear-facing LED assembly to flash.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A hazard flasher system for a personal motor vehicle, the hazard flasher system comprising:
a first light-emitting diode (LED) assembly constructed to mount to the personal motor vehicle such that light emitted by a first LED in the first LED assembly is projected generally forward from the personal motor vehicle;
a second LED assembly constructed to mount to the personal motor vehicle such that light emitted by a second LED in the second LED assembly is projected generally rearward from the personal motor vehicle; and
a circuit board that, when the hazard flasher system has been activated, utilizes direct current electrical energy from a primary battery of the personal motor vehicle to output periodic pulses of electrical energy to the first LED and the second LED, the pulses of electrical energy causing the first LED and the second LED to flash.

2. The hazard flasher system of claim 1, further comprising a lead connected to the first LED, the second LED, and the circuit board, the lead transmitting the pulses of electrical energy from the circuit board to the first LED and the second LED.

3. The hazard flasher system of claim 1, wherein the first LED and the second LED are connected to the lead in series.

4. The hazard flasher system of claim 1, wherein the circuit board is designed to operate when the electrical energy from the primary battery has a voltage ranging from approximately 6.25 volts to 15 volts.

5. The hazard flasher system of claim 1, wherein the circuit board is wired to the primary battery such that the circuit board is able to receive electrical energy from the primary battery when the personal motor vehicle is not in an “on” state.

6. The hazard flasher system of claim 5, wherein the circuit board is wired to the primary battery such that the circuit board is able to receive electrical energy from the primary battery when an ignition key of the personal motor vehicle has been removed from an ignition switch of the personal motor vehicle.

7. The hazard flasher system of claim 1, wherein the first LED and the second LED are LEDs capable of handling pulses of electrical energy having amperages ranging from at least 350 milliamps to 400 milliamps

8. The hazard flasher system of claim 1,
wherein the circuit board is designed to output the pulses of electrical energy at a rate of approximately 0.67 hertz, and
wherein the circuit board is designed to output the pulses of electrical energy such that each of the pulses occurs approximately every 1.5 seconds.

9. The hazard flasher system of claim 1, further comprising a dashboard LED suitable for mounting in a dashboard of the personal motor vehicle to alert a driver of the personal motor vehicle whether the hazard flasher system has been activated.

10. A personal motor vehicle comprising:
an internal combustion engine that drives the personal motor vehicle;
a primary battery that stores electrical energy;
a starter motor that uses electrical energy from the primary battery to start the internal combustion engine; and
a hazard flasher system that comprises:
a first light-emitting diode (LED) assembly mounted to the personal motor vehicle such that light emitted by a first LED in the first LED assembly is projected generally forward from the personal motor vehicle;
a second LED suitable mounted to a rear end of the personal motor vehicle such that light emitted by a second LED in the second LED assembly is projected generally rearward from the personal motor vehicle; and
a circuit board that, when the hazard flasher system has been activated, utilizes direct current electrical energy from the primary battery of the personal motor vehicle to output periodic pulses of electrical energy to the first LED and the second LED, the pulses of electrical energy causing the first LED and the second LED to flash.

11. The personal motor vehicle of claim 10, further comprising:
a set of front turn signals; and
a set of rear turn signals.

12. The personal motor vehicle of claim 10,
wherein the personal motor vehicle further comprises a dashboard;
wherein the hazard flasher system comprises a dashboard LED mounted in the dashboard; and
wherein the circuit board outputs the periodic pulses of electrical energy to the dashboard LED, thereby causing the dashboard LED to flash.

13. The personal motor vehicle of claim 12, wherein the personal motor vehicle comprises a switch integrated into the dashboard that turns the hazard flasher system on and off.

14. The personal motor vehicle of claim 10, wherein the circuit board is designed to operate when the electrical energy from the primary battery has a voltage ranging from approximately 6.25 volts to 15 volts.

15. The personal motor vehicle of claim 10, wherein the first LED and the second LED are LEDs capable of handling pulses of electrical energy having amperages ranging from at least 350 milliamps to 400 milliamps

16. The personal motor vehicle of claim 10,
wherein the circuit board is designed to output the pulses of electrical energy at a rate of approximately 0.67 hertz, and
wherein the circuit board is designed to output the pulses of electrical energy such that each of the pulses occurs approximately every 1.5 seconds.

17. The personal motor vehicle of claim 10, wherein the personal motor vehicle is a motorcycle.

18. A method of installing a hazard flasher system on a personal motor vehicle, the method comprising:
installing a forward-facing light-emitting diode (LED) assembly on the personal motor vehicle such that light emitted by an LED in the forward-facing LED assembly is projected generally forward from the personal motor vehicle;
installing a rear-facing LED assembly on the personal motor vehicle such that light emitted by an LED in the rear-facing LED assembly is projected generally rearward from the personal motor vehicle;
attaching a lead wire to an electrical system of the personal motor vehicle, the electrical system of the personal motor vehicle deriving electrical energy from a primary battery of the personal motor vehicle;
attaching a return wire to the electrical system of the personal motor vehicle;
installing a circuit board attached to the lead wire and the return wire, the circuit board utilizing direct current (DC) electrical energy provided by the electrical system to output periodic pulses of electrical energy to the forward-facing LED assembly and the rear-facing LED assembly, the pulses of electrical energy causing the LED in the forward-facing LED assembly and the LED in the rear-facing LED assembly to flash.

19. The method of claim 18, wherein the circuit board is designed to handle voltages from the electrical system that range from 6.25 volts to 15 volts.

20. The method of claim 18, wherein the personal motor vehicle is a motorcycle that has turn signals that use incandescent light bulbs.
